(19) United States
(12) Patent Application Publication
(10) Pub. No.: US 2014/0006260 A1
(43) Pub. Date: Jan. 2, 2014

(54) Employment System and Method

(71) Applicant: John H. Pilcher, Alexandria, VA (US)

(72) Inventor: John H. Pilcher, Alexandria, VA (US)

(21) Appl. No.: 13/539,602

(22) Filed: Jul. 2, 2012

(51) Int. Cl. G06Q 10/06; G06Q 40/00

(52) U.S. Cl. 705/39; 705/321

(57) ABSTRACT

The invention is a distribution system and method between Applicants, Employers and Third-party Recruiters designed to i) empower applicants to overcome the information overload problem of other Job Search Systems and have their credentials viewed by Employers, ii) affirmatively reduce profiling and discriminatory screening by Employers, iii) allow Applicants to execute national advertising job campaigns with complete anonymity, iv) bring new marketing information and tools to the Applicant's job search, v) streamline the search process for Employers to increase the number of Applicants that can be reviewed in an allotted time period, vi) empower Employers with ability to reduce their first year hiring costs, and vii) facilitate job creation by providing for the orderly transfer of the Financial Offer from the Applicant to the Employers through escrow procedures.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to the field of employment systems. More particularly, the invention relates to a system and method of Internet based interaction between Applicants, Employers and Third-party Recruiters.

2. Description of the Related Art

Job search sites currently provide, via the Internet, various types of message boards and career sites (“Job Search Systems”) that list job postings and/or job Applicant resumes and that allow the exchange of information between Employers and Applicants. These types of Job Search Systems focus on the collection, storage, retrieval, and keyword searching of either job posting or job Applicant material. For example see U.S. Pat. No. 5,832,497. Such Job Search Systems envision charging fees for access to such databases as well as related fees derived from advertising, and resale of customer-related information.

The Job Search Systems have drawbacks that limit their value to both Applicants and Employers. The first drawback is information overload for Employers. Employers have limited time available to review resumes and this has led to increased mechanical screening of resumes prior to an actual review of an Applicant's credentials. Mechanical screening however, enhanced by software systems, often provides inadequate results for the Employers. Information overload also hinders the job search of qualified Applicants. For such Applicants, there are no assurances that their qualifications will be seen by Employers because of the sheer number of resumes posted on such sites. Applicants, as a result, often receive little or no responses from continuous submissions on such Job Search Systems. This problem is recognized by many career advisors and press articles that recommend Applicants rely mostly on their personal network and “friends and family” to find a job. Of the currently unemployed, a significant number are or feel disenfranchised and give up searching altogether because of no responses from Employers. On Sep. 4, 2007, the U.S. Patent Office recognized this shortcoming in current Job Search Systems by issuing U.S. Pat. No. 7,266,523, for an electronic interview auction method for auctioning an interview for a job. While well intended, attempting to auction an interview is not an effective approach to the applicant and employer challenge and does not help to lessen the problem or succeed in the market place.

The second drawback is that the current Job Search Systems do not provide more innovative methods to reduce either intentional or unintentional profiling by Employers based on race, religion, age, and increasingly unemployment status. Patents have been submitted to help monitor Employers compliance with federal affirmative action laws For example, see US Publications 2002/0052777 and 2011/0231329. However, such patents are for after-the-fact monitoring systems. The patents do not provide a controlled process specifically designed to reduce such discrimination during, and throughout, the employer's search process. At present, other job search-systems have not implemented a method to provide a controlled interaction with the consumer via the Internet that incentivizes Employers to focus only on Applicant's credentials without profiling and prescreening.

The third drawback is that Applicants, who want to promote their resumes nationally via the Internet, must give up control of their anonymity. This curtails the rights of Applicants to advertise nationally because of the potential disclosure to current Employers. Currently, Applicants who release their resumes to national Job Search Systems risk disclosure and resulting adverse actions by their current Employers. Existing Internet sites do not provide a process that allows Applicants to promote successfully their credentials nationally, while remaining anonymous until a specific Employer or Recruiter requests their resume.

The fourth drawback is that current Job Search Systems do not provide Applicants with marketing information necessary to execute a successful marketing campaign for their next career step. Job Search Systems do not currently provide Applicants with information such as: i) how saturated a particular geographic area is with similar Applicants; ii) what the quality is of Applicants who are competing against the job Applicant and iii) whether the Applicant's promotional material is successfully reaching and being read by the target employer audience. Applicant job searches, via the Internet, are one of the few business areas where technology does not provide the Applicant advertiser with adequate marketing information to execute a successful marketing campaign.

The fifth drawback is that the traditional method of reviewing cover letters and resume reviews are cumbersome and aggravate the information overload problem discussed in this section. Existing Job Search Systems attempt to address this by mechanically prescreening the Applicants' resumes based on key words and other preformatted criteria. For example see, www.monster.com for an example of such a system. This mechanical prescreening, however sophisticated, is inadequate to ensure that Employers are seeing the credentials of the best Applicants. The mechanical attempts often result in many Applicants “gaming” the system through key word additions which results in other qualified Applicants being eliminated without their credentials being reviewed. There is a definite need for a controlled process to allow Employers to review more qualified Applicant's credentials within a limited period.

The sixth drawback is that current Job Search Systems do not attempt to provide more innovative methods to Employers to address the increasing costs of hiring new Applicants. In the current economy, cash-strapped growing companies are burdened by increasing costs related to hiring such as medical benefits, administration and training costs. The utilization of third party Recruiters is another hiring related cost expended by many employers to find and screen Applicants. All these additional costs slow the growth of companies by slowing the ability to finance the hiring of new talent. In aggregate, this problem slows the growth of the employment rolls, and the health of the economy. No current Job Search Systems or patents focus on this subject or seek controlled interactive system innovations to address this problem.

### SUMMARY OF THE INVENTION

In a preferred embodiment, a programmed computer software system and method is disclosed that provides a controlled interaction between Applicants, Employers and Third-party Recruiters via an Internet Website.

The system and method are implemented via a website on the Internet wherein Applicants provide a Financial Offer to Employers to view the Applicant's Credentials Document (“ACD”). The Financial Offer is a non-binding offer to pay the Employer a set financial amount, if and when the Applicant is hired. The Financial Offer creates an incentive for the Employer to review the Applicant's Credentials Document and other information that describes the Applicant's credentials. The Applicant's Credentials Document is a preformatted summary of the Applicant's career highlights. The Financial Offer encourages Employers to view the Applicant's Credential Document and request the Applicant's resume. The Employer's request for Applicant's resume is transmitted to the Applicant through the website of the invention. The Employer's identity is confidential until the resume is requested. The Applicant's identity is confidential until they respond to the Employer's request.

It should be understood that reference to the website of invention includes the underlying database that is incorporated into the website to store, retrieve and manipulate data for use by the inventive steps described herein.

The system and method of the invention provide goals, functions, tools and benefits not contained in other Job Search Systems. The invention provides financial and social benefits not currently provided in the market place.

In a preferred embodiment, the invention includes an electronic employment method via a computer database accessible on a website on the Internet for networking and finding a job, wherein the database is located on computer hardware for storing and retrieving information and wherein the method comprises the steps of:
registering by an Applicant in the database;
completing by Applicant a predefined Credentials Document that summarizes Applicant's career points and storing the Credentials Document in the database;
completing by Applicant a form that includes criteria that will allow others to search for and find Applicant's Credentials Document and the criteria is stored in the database; making a non-binding offer by the Applicant to pay a set financial amount to an Employer, if and when hired;
allowing the Applicant to search for job postings on the database through the website and allowing the Applicant to send Applicant's Credentials Document to the job postings;
allowing Applicant's Credentials Document to be searched for and found by prospective Employers;
allowing the Applicant to receive requests for the Applicant's resume from prospective Employers that have accessed and viewed Applicant's Credentials Document;
allowing Applicant to review and determine whether or not to release Applicant's resume to requesting Employer; and
allowing Applicant to pay the set financial amount, if and when hired, to the hiring Employer over a predetermined period of time.

The electronic employment method can also include the steps of:
registering by an Employer in the database;
completing job posting material by the Employer and storing the job posting material in the database;
completing a form by the Employer that includes criteria that will allow others to search for and find the job posting material and storing the criteria in the database;
providing the Employer with a personal account wherein Employer can find and maintain Applicants' Credentials Documents sent in response to a job posting;
allowing the Employer to search and find Applicants' Credentials Documents;
allowing the Employer to access and view Applicants' Credentials Documents; and
allowing the Employer to request an Applicant's resume from Applicant's Credentials Document.

The Applicant may be required to pay a registration fee when registering.

In a preferred embodiment the inventive employment system is provided via the Internet on a website comprising:
a database on computer hardware for registering an Applicant;
the database being accessible on a website of the Internet;
a form in the database that includes fields for Applicant to complete with data to be included in an Applicant's Credentials Document and stored in the database;
a financial offer field to be completed with data in the database by the Applicant;
said financial offer comprises a set financial amount;
the Applicant's Credentials Document in the database being searchable by Employers, Third-party Recruiters and unregistered users;
the database includes provision to allow registered Employers and Third-party Recruiters to request resume from selected Applicant and a provision to allow Applicant to determine whether or not to release Applicant's resume from the database to the requesting Employer or Third-party Recruiter; and
the database includes a provision to allow Applicant to pay the set financial amount to Employer or Third-party Recruiter over a predetermined period of time.

Specifically, as will be described Item by Item below, the invention includes the following objects and advantages:
Empower Applicants to overcome the information overload problem of other Job Search Systems and have their credentials viewed by Employers (Item I).
Affirmatively Reduce Profiling and Discriminatory Screening (Item II).
Allow National Advertising for the Applicant with Complete Anonymity (Item III).
Bring New Marketing Information and Tools to the Applicant's Job Search (Item IV).
Streamline the Search Process for Employers to Increase Number of Applicants that can be reviewed in an Allotted Time Period (Item V).
Empower Employers with the Ability to Reduce Their First Year Hiring Costs (Item VI).
Facilitate Job Creation by providing for the Orderly Transfer of the Financial Offer from the Applicant to the Employer through Escrow Procedures (Item VII).

### I. A. The Financial Offer: Promoting the Applicant's Credentials Document

Applicants must register to enroll on the website of the invention and complete a pre-formatted Applicant's Credentials Document focused on three types of credentials, i.e. Experience, Expertise, and Accomplishments. They must also fill out criteria that allow Employers to search and find their Applicant's Credentials Document. The next step allows Applicants to promote their Credentials Document by inputting a Financial Offer. This Financial Offer is a non-binding offer from the Applicant to pay a set financial amount to offset an employer's first year hiring costs if and when Applicant is hired by the Employer. The amount of the Financial Offer is entirely up to the Applicant and does not contractually bind the Applicant. It is a starting point for the Applicant and future Employer to begin discussions prior to a hiring offer. The Applicant can change the amount of the Financial Offer anytime through interaction with the website of the invention.

The Financial Offer is a promotional tool for the Applicant and encourages the Employer to view the Applicant's Credentials Document. The Financial Offer can be obtained by the Employer if after reviewing the Applicant's Credentials Document, the Employer requests a resume and subsequently hires the Applicant.

### I. B. The Employer Review: Contacting the Applicant

Employers and Third-part Recruiters must register to enroll on the website of the invention and are given personal Account Pages, which act as a Dashboard, i.e. a page with tools that allow them to post job openings and receive Applicant's Credentials Documents, or alternatively to just search for Applicant's Credentials Documents based on predefined criteria.

Employers and Third-party Recruiters must deal with a physical limitation to their search for the ideal Applicant. This restriction is the amount of time an employer or recruiter has to complete their talent search. On the website of the invention, Employers are encouraged to use a small allotment of their time to review an Applicant's Credentials Document. This review is the only way on the website of the invention for an Employer to request a resume and contact the Applicant. The Applicant's identity is confidential until the Applicant sends the resume to the Employer. Therefore, reviewing the Applicant's Credentials Document is the only way to contact the Applicant and potentially obtain the Financial Offer.

### II. Affirmatively Reduce Profiling and Discriminatory Screening

Currently, Applicants have no market power to prevent profiling and prescreening of their application material based on age, sex, religion or employment status. The Financial Offer (described in Item IA of this Section), provides Applicants with market power to incentivize Employers to allot time to review the Applicant's credentials through the Applicant's Credentials Document. The Financial Offer is an affirmative action tool, which will level the playing field for many Applicants. Through the market power of the Financial Offer, the Applicant obtains from the Employer an actual review of the Applicant's credentials. This overcomes the first profiled prescreening stage of many employer talent searches.

The Financial Offer also becomes a factor in the employer's entire review when subsequently an employer, after reviewing qualified credentials, then requests through the website of the invention an actual resume. Entering the final review process with qualified credentials and the Financial Offer provides the Applicant a fairer review opportunity. At this stage, the employer is allocating more time to focus on a talented person capable of showing a financial interest in their future and the employer's future. The Financial Offer therefore plays a strong counter-force to profiling and discrimination, whether intentional or unintentional, throughout the Employer's talent search.

III. Allow National Advertising for the Applicant with Complete Anonymity

On the website of the invention, Applicants have the power to advertise their credentials nationally to all Employers, whether the employer is registered or not on the website of the invention. Nationally, via the Internet, Employers can see the advertised Credentials Document and can register and request, through the website of the invention, the Applicant's resume. Upon receiving the employer's request, the Applicant can research the employer via the Internet and choose whether to release their resume and identity on an individual basis. The website of the invention, therefore, provides Applicants with a viable market process to initiate and execute national advertising campaigns without risking disclosure and adverse reactions from their current Employers.

### IV. Bring New Marketing Resources, Information and Tools to the Applicants' Search

Current Job Search Systems do not provide Applicants with the market power or marketing information necessary to execute a successful marketing campaign for their next career position. In response, the website of the invention brings modern marketing tools, knowledge and techniques to the Applicant's search process.

First, in other areas of business, corporations can increase their probability of success by bringing more resources to the marketing campaign. The website of the invention provides this marketing concept to the Applicant through the power of the Financial Offer, which incentivizes Employers to allot time to review to the Applicants credentials in the Applicant's Credentials Document.

Second, on the website of the invention, all Applicants can see and review the nationally advertised Applicant's Credentials Documents of other similar Applicants. This provides Applicants with real-time market knowledge of how saturated a particular geographic market with similar competition and the quality of their competition. In response, the Applicants can modify and improve their Applicant's Credentials Document and Financial Offer in order to improve their chance of successfully marketing and reaching the eyes of employer's. Alternatively, Applicants may choose to market in different geographic areas where they now have knowledge of less market saturation.

Third, the invention provides Applicants with continuous feedback on two important gauges of their marketing success; i) how many times unregistered viewers have reviewed their Applicant's Credentials Document and ii) how many registered Employers and Third-party Recruiters have reviewed their Applicant's Credentials Document. This information also provides the Applicant with important marketing information regarding the impact of their marketing campaign, and whether additional modifications to either the Applicant's Credentials Document or Financial Offer are required.

Fourth, Applicants will know on the website of the invention whether their credentials are sufficient to attract employer's interest as all Employer requests for resume go through the website of the invention directly to the Applicant. In summary, the invention brings new marketing resources, marketing tools, and information to the Applicant. The invention turns a job search into a state-of-the-art career marketing campaign.

### V. Streamline the Process for Employer Reviews

On the website of the invention, Employers can either search for relevant Applicants or post job openings and have receive Applicant's material sent directly to their personal Account page. In direct search initiatives on the website of the invention, the key words and criteria used are generic and do not attempt to accomplish any sophisticated prescreening for the employer. In the case of job postings, the employer receives all responses from interested Applicants that are registered in the database on the website of the invention.

The invention therefore, is not intended to be a mechanical prescreening or matching system like many other Job Search Systems. On the website of the invention, Employers must allot time to review job Applicant material directly, which eliminates inadequate prescreening results. Next, the invention addresses information overload by Employers by formatting and processing techniques that occur in two steps.

First, the invention transforms all job Applicant materials into an aggregate Search Results screen that describes each Applicant by a short list of criteria, which may include an Account #, Career Category, Job Title, Geographic Area, Applicant's Credentials Document (“ACD”), Desired Salary Range and Financial Offer. From this Search Results screen, all Applicants on the page can be sorted by any of the criteria for the Employer's review. The Employer can them click on any Applicant's Credentials Document on the page to bring up the Applicant's Credentials Document that corresponds to the selected Applicant.

Second, the Applicant's Credentials Document is a preformatted digest of the Applicants credentials that are divided into three categories: Experience, Expertise, and Accomplishments. Each category consists of one paragraph of condensed information regarding the Applicant. This format is designed so that an Employer can review credentials within seconds and click to the next Applicant's Credentials Document sequentially. When the Employer finds an Applicant with the desired credentials, the Employer can quickly click a “Request Resume” tab and then move on the next Applicant's Credentials Document.

The processes of the Search Results Screen and the Applicant's Credentials Document are designed to replace the less desirable mechanical prescreening and matching processes of other Job Search Systems. The inventive processes control the interaction of Applicants, Employers and Third-party Recruiters in order to return the first prescreening process to the eyes of the Employer with a method that allows the Employer to review many Applicants' credentials in the time normally allotted for just one resume.

VI. Empower Employers with the Ability to Reduce First Year Hiring Costs

This invention directly addresses the supply-side problem in the employment market by empowering Employers with the ability to reduce their first year hiring costs. On the web site of the invention, registered Applicants offer potential Employers a Financial Offer. The Financial Offer is a non-binding offer from the Applicant to pay a set financial amount to offset an Employer's first year hiring costs if and when the Applicant is hired by the Employer. Registered Employers that allot time to review the Applicant's Credentials Document can obtain this valuable option if and when they hire the Applicant.

The invention transforms the traditional job search system into a controlled new process for Employers to reduce their first year hiring costs. In doing so, the invention seeks to further the common good for all, by accelerating the ability of Employers individually, and in aggregate, to add to the employment rolls, to reduce unemployment, and to further the overall growth of the economy.

VII. Facilitates Job Creation by Providing for the Orderly Transfer of the Financial Offer from the Applicant to the Employer through Escrow Procedures

The invention further facilitates the job creation goal described under Item VI of this section by providing for the orderly transfer of the Financial Offer over a period of time from the Applicant to the Employer or Third-party Recruiter through an escrow process. In a preferred embodiment, the escrow agreement is initiated by the Applicant upon employment by the Employer. This escrow process allows the Applicant to transfer the Financial Offer to the Employer or Third-party Recruiter on a pro-rated monthly basis during the first year of employment. If the employment position terminates during the first year, for any reason, the remainder funds in the escrow account are returned to the Applicant or Third-party Recruiter. This escrow process protects the financial interests of both the Employer or Third-part Recruiter and Applicant in a controlled manner that completes the purpose of the invention. The invention brings new financial, economic, and social benefits to Applicants and to Employers or Third-party Recruiters through a controlled interaction with and between the parties via an Internet website.

### BRIEF DESCRIPTION OF THE DRAWINGS

FIG. 1 shows Chart I, which illustrates the steps of the process steps performed by an Applicant.

FIG. 2 is a continuation of Chart I from FIG. 1.

FIG. 3 shows Chart II, which illustrates the steps of the process performed by an Employer.

FIG. 4 is a continuation of Chart II from FIG. 3.

FIG. 5 shows Chart III which illustrates the steps of the process performed by unregistered users.

FIG. 6 shows Chart IV which illustrates the steps of the process performed by a Third-party Recruiter.

FIG. 7 shows is a continuation of Chart IV from FIG. 6.

FIG. 8 shows a Search Results Spreadsheet containing Applicants' data.

FIG. 9 shows an example of an Applicant's Credentials Document showing Experience, Expertise and Accomplishments.

### DETAILED DESCRIPTION OF THE INVENTION

Refer now to the Charts in the drawings as indicated in the following table:

| Chart: | FIGS. | Focus: |
|---|---|---|
| I | 1 and 2 | Applicants |
| II | 3 and 4 | Employers |
| III | 5 | Unregistered users |
| IV | 6 and 7 | Third-party Recruiters |

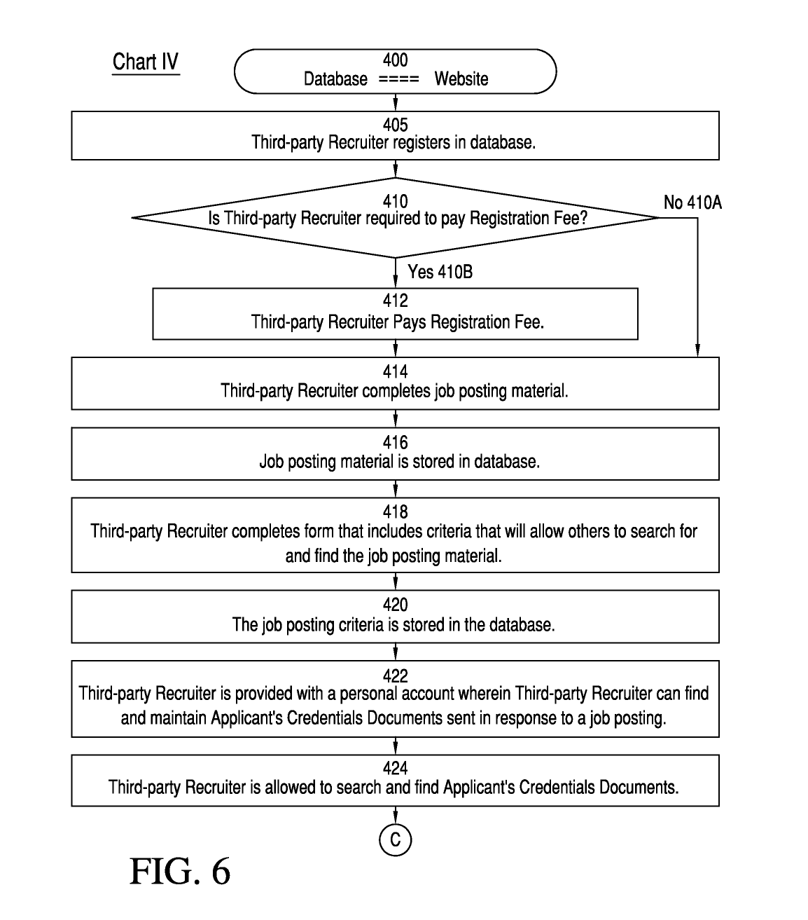

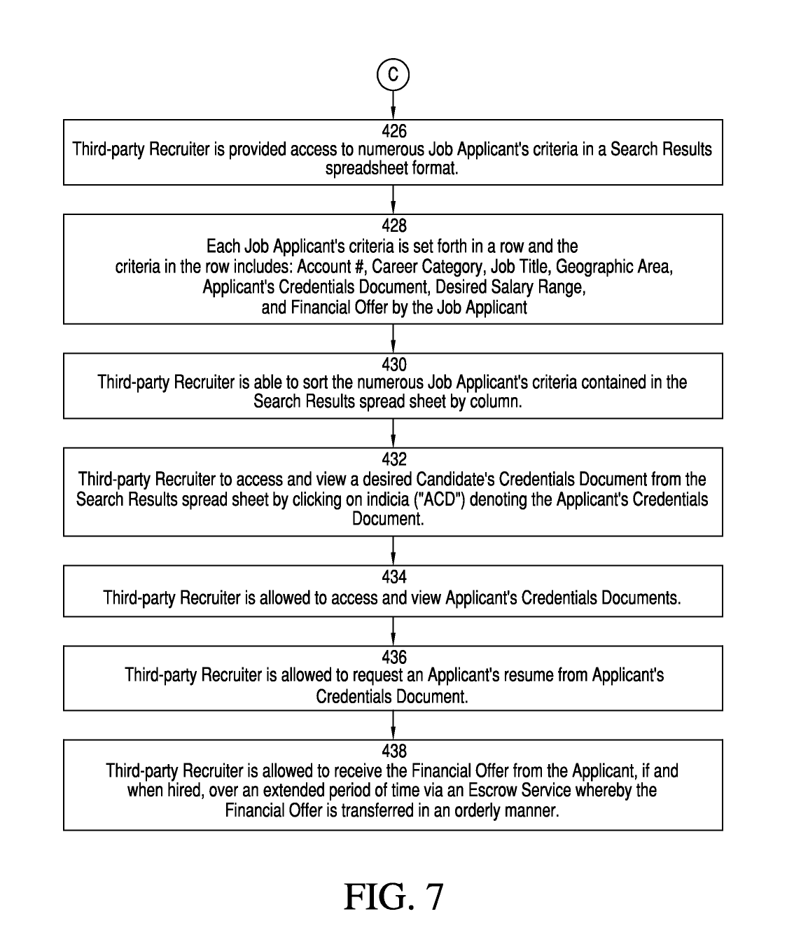

In a first step, Employers and Third-party Recruiters are allowed to enroll and have full access to the utility of the invention via the Internet at no cost. Reference to Recruiters is used interchangeably with the term Third-party Recruiters in this document as illustrated in Chart IV in FIGS. 6 and 7. Employers and Recruiters are required to fill out their company and key contact information and register (205, 405). The utilities Employers and Third-party Recruiters access includes advertising job openings (job postings), inputting criteria into the website of the invention's search engines to facilitate the ability of other users to search and find the job postings, and searching for Applicant's and requesting Applicant's Credentials Documents as described below. Job postings will be publicly and nationally advertised via the Internet, but the access to interact and contact the Employers and Third-party Recruiters on the website of the invention is limited to enrolled Applicants described in the third step, as follows. The Employer's and Recruiter's identities are not disclosed in the job postings.

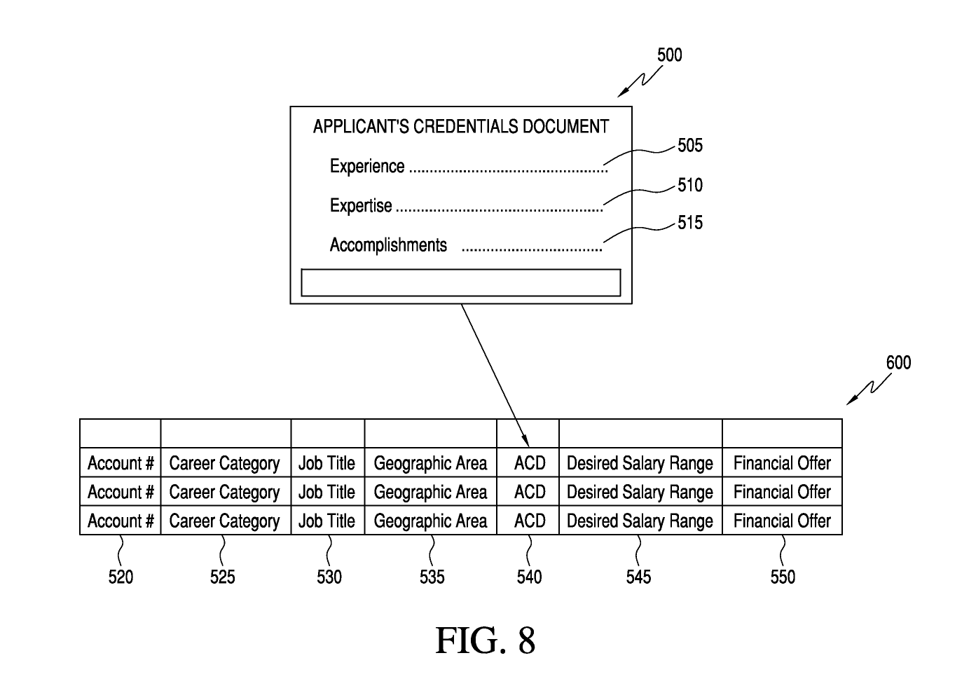

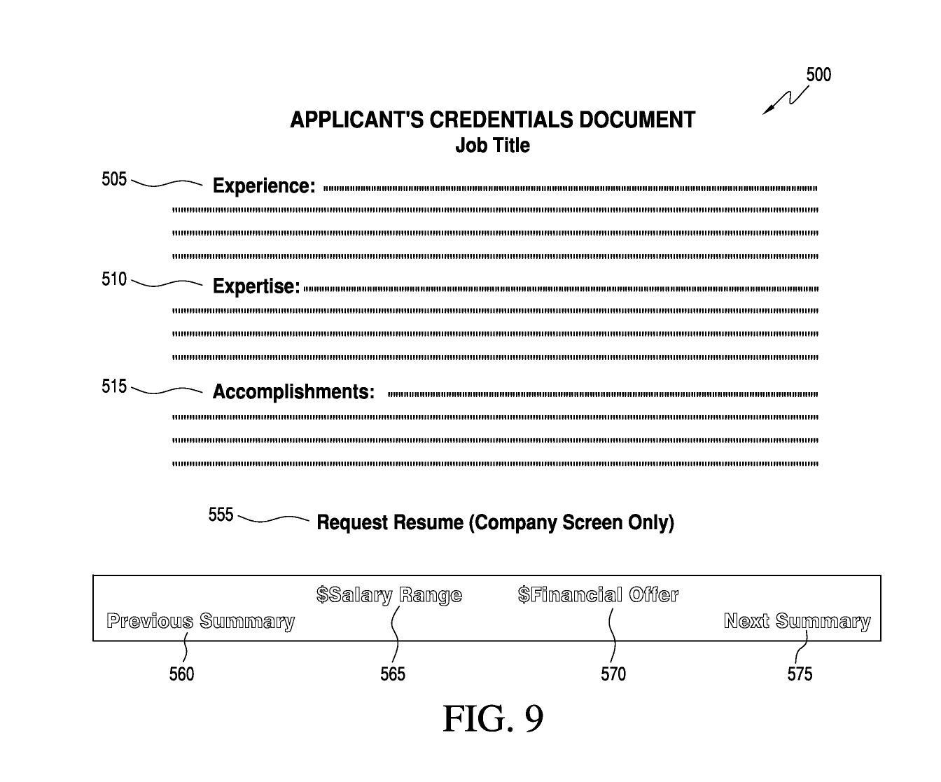

A second step allows Applicants to register for a fee (110B) to utilize the website of the invention and requires they fill out searchable data fields (122), which includes making a Financial Offer (128). The Financial Offer is a non-binding offer from the Applicant to pay a set financial amount over a period of time to the Employer, if and when hired, by the Employer in order to offset the Employer's first year hiring costs. The Applicant also fills out a predefined format called an Applicant's Credentials Document (115), which summarizes the Applicant's career credentials into three categories: Experience, Expertise and Accomplishments (120). This is not a resume but a concentrated highlight of the Applicant's career. The Applicant's Credentials Document 500 (FIGS. 8 and 9) is the Applicant's primary promotional tool. The Applicant's Credentials Document 500 is devoid of any status information on race, national origin, sex, age or current employment status. The Applicant's Credentials Document 500 will be searchable by the public but the ability to request an Applicant's resume will be restricted to registered Employers and Recruiters. The Applicant's identity is not disclosed in the Applicant's Credentials Document 500.

A third step allows Applicants to have access to important marketing information including the ability to see all other Applicants' Credentials Documents 144 and the Financial Offers, otherwise referred to as non-binding offers. Applicants can also review how many times their own Applicant's Credentials Document 500 has been viewed by registered Employers and Recruiters, as well as the unregistered public 146. Based on this marketing information, Applicants can always modify their own Applicant's Credentials Document and other inputted data, including the Financial Offer, to improve their own marketing position in relation to the competition 148.

A fourth step allows an Employer, Third-party Recruiter, Applicant or unregistered user to view a Search Results Page 600, which shows all Applicants found from a Search Applicants action, or alternatively, shows all Applicants that responded to the Employer's or Third-party Recruiter's job postings. The Search Results Page 600 (See FIG. 8) is designed to show each Applicant's criteria in rows including:

i. Account #520;

ii. Career category 525;

iii. Job title 530,

iv. Geographic area 535,

v. Applicant's Credentials Document (“ACD”) 540,

vi. Desired salary range 545, and

vii. Financial Offer 550.

Employers and Recruiters (and unregistered users) can also sort Applicants on the Search Results Page 600 by criteria. For example, to arrange Applicants by highest or lowest desired salary or Financial Offer, the heading: Desired Salary Range, or Financial Offer; respectively, would be clicked.

A fifth step allows an Employer and Recruiter to access and view an Applicant's Credentials Document 500 by clicking on the corresponding Applicant's Credentials Document link 540 (identified as ACD) in the Search Results Page (See FIG. 8). From the Applicant's Credentials Document 500, an Employer and Third-party Recruiter can then request the Applicant's resume 555 (See FIG. 9). Applicants and unregistered users can utilize only part of this step. In other words, Applicants and unregistered users can access and view an Applicant's Credentials Document 500, but they cannot request a resume. Only a registered Employer or Third-party Recruiter can request a resume and contact the Applicant through the website of the invention. The Employer's or Third-part Recruiter's identity is finally disclosed to the Applicant when the resume request is made at this step.

A sixth step, allows the Applicant to independently research the Employer or Third-party Recruiter to decide whether or not to reply by email directly to the Employer or Third-party Recruiter. The Applicant's identity is finally disclosed to the Employer or Recruiter only if the Applicant sends the Applicant's resume to the Employer or Third-party Recruiter. All further contacts, interviews and hiring decisions, including the final negotiated amount of the Financial Offer are handled privately between the Applicant and the Employer Third-party Recruiter.

A seventh step allows Applicants to arrange an escrow agreement if and when they are hired by the Employer or the Third-party Recruiter. This escrow process allows the Applicant to transfer the Financial Offer to the Employer on a pro-rated monthly basis during the first year of employment. If the employment position terminates during the first year, for any reason, the remainder funds in the escrow account are returned to the Applicant. This escrow process protects the financial interests of both the Employer or the Third-party Recruiter and the Applicant in a controlled manner that facilitates the innovative job creation process.

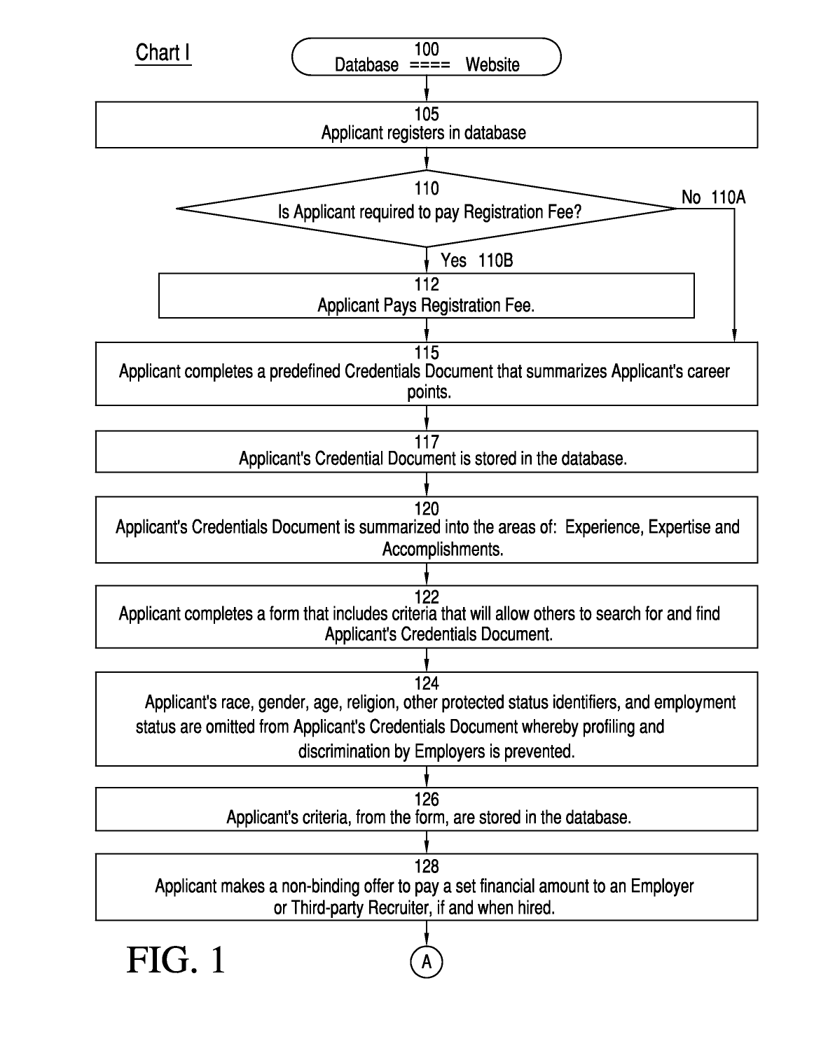

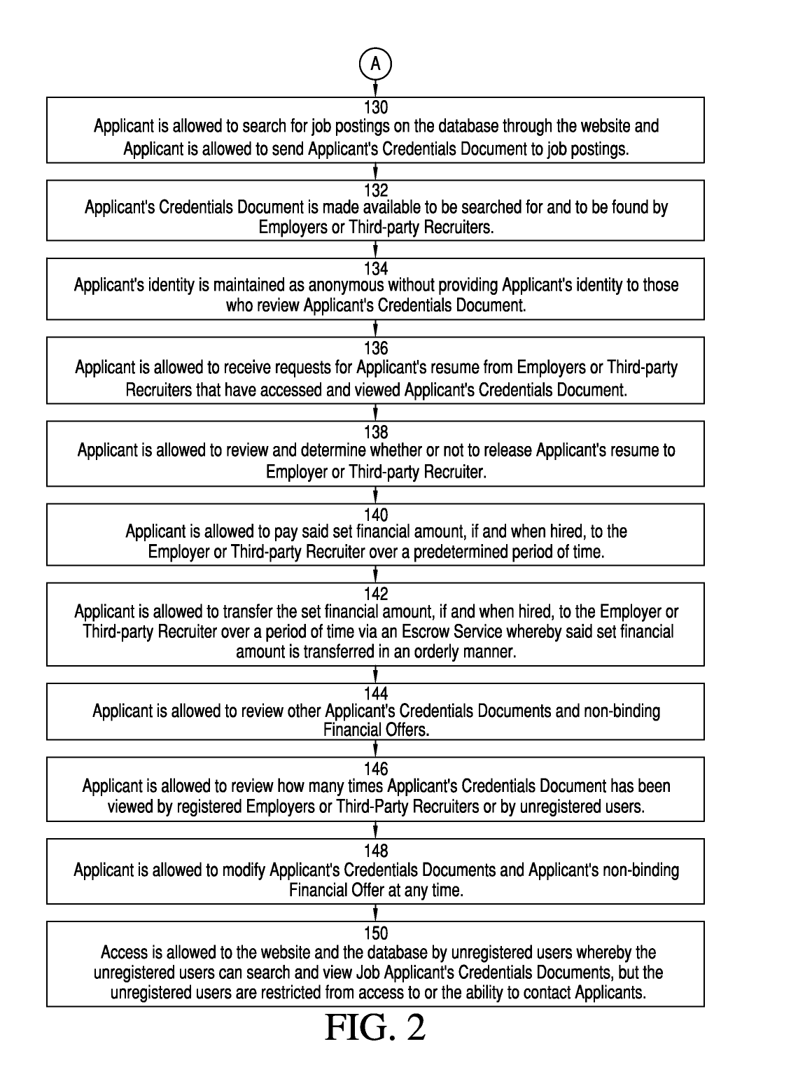

Refer now to FIGS. 1-7, in which FIGS. 1-2 show Chart I, which illustrates the sequence of steps provided in the invention for an Applicant. The inventive website includes a database 100. Upon visiting the website the Applicant registers in the database 105. The invention by default is configured to require Applicant to pay a registration fee 110B, but may also be configured to not require a registration fee 110A. For example, limited time promotions may be offered to new Applicants or Applicants in specific in career categories or other selected criteria may be allowed to register without cost.

Next Applicant completes a predefined Applicant's Credentials Document (also referred to as “ACD”) at 115 that summarizes Applicant's career points. The ACD is then stored in the database of the website at step 117. The ACD is summarized into the areas of: Experience, Expertise and Accomplishments at step 120. At step 122 Applicant completes a form that includes criteria that will allow others, such as Employers and Third-party Recruiters to search for and find the ACD for the Applicant. Step 124 requires that Applicant's race, gender, age, religion other protected status identifiers, and employment status are omitted from the ACD. This prevents profiling and discrimination by Employers and/or Third-party Recruiters. The criteria may include more or less items, depending upon which factors may cause potential profiling or discrimination. Applicant's criteria, from the form, are then stored in the database of the website in step 126. Applicant makes a non-binding financial offer, referred to as the Financial Offer, in step 128. The Financial Offer is paid to the Employer (or Third-party Recruiter) if and when Applicant is hired.

In step 130 Applicant is allowed to search for job postings through the inventive website and is allowed to send his or her ACD to job postings. Applicant's Credential Document is made available to be searched for and to be found by Employers or Third-party Recruiters in step 132. Applicant's identity is maintained as anonymous without providing Applicant's identity to those who review Applicant's Credentials Document 134. In step 136 Applicant is allowed to receive requests for Applicant's resume from Employers or Third-party Recruiters that have accessed it and viewed Applicant's Credentials Document. Applicant is allowed to review Employer or Third-party Recruiter and determine whether or not to release Applicant's resume to the requesting Employer in step 138. In step 140 Applicant is allowed to transfer the set financial amount, if and when hired, to the Employer or the Third-party Recruiter over a period of time. Applicant is allowed in step 142 to transfer the set financial amount (the Financial Offer), if and when hired, to the Employer or Third-party Recruiter over a period of time via an Escrow Service whereby the set financial amount is transferred in an orderly manner. In step 144 Applicant is allowed to review other Applicant's Credentials Documents and Financial Offers. Applicant is also allowed to review in step 146 how many times his or her Applicant's Credentials Document has been viewed by registered Employers, Third-party Recruiters or by Unregistered Users. Applicant is allowed in step 148 to modify Applicant's Credentials Document and Applicant's Financial Offer at any time. Finally in step 150, access is allowed to the website and the database of the website by unregistered users whereby the unregistered users can search and view Applicants' Credentials Documents, but the unregistered users are restricted from access to or the ability to contact Applicants.

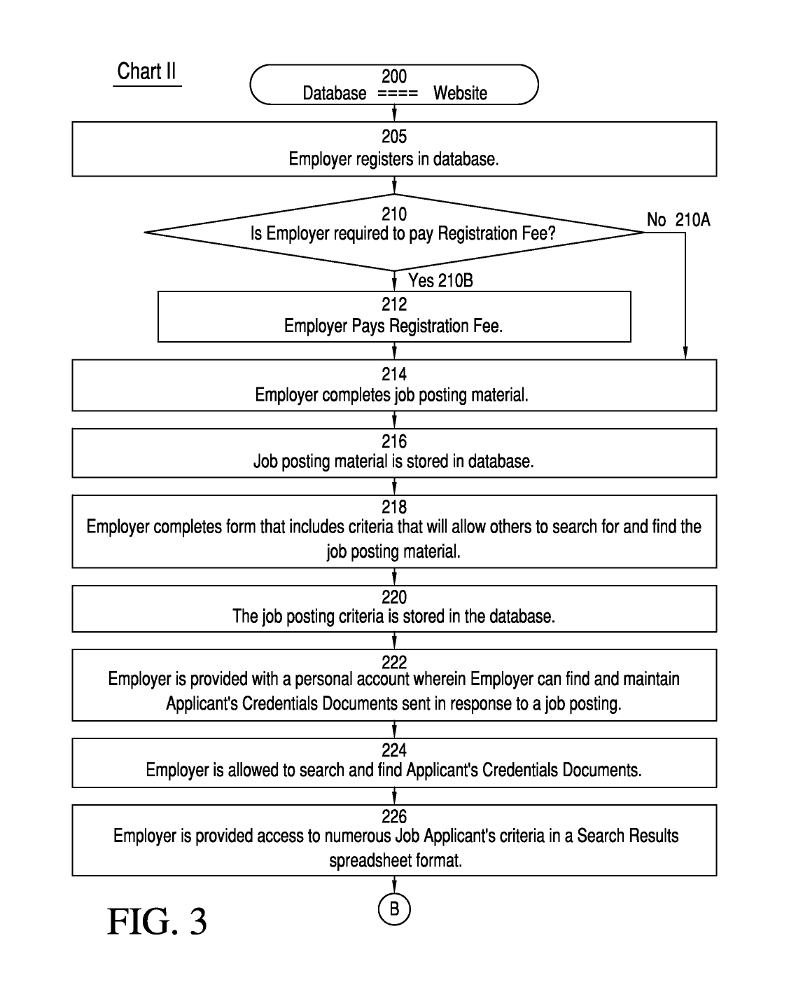

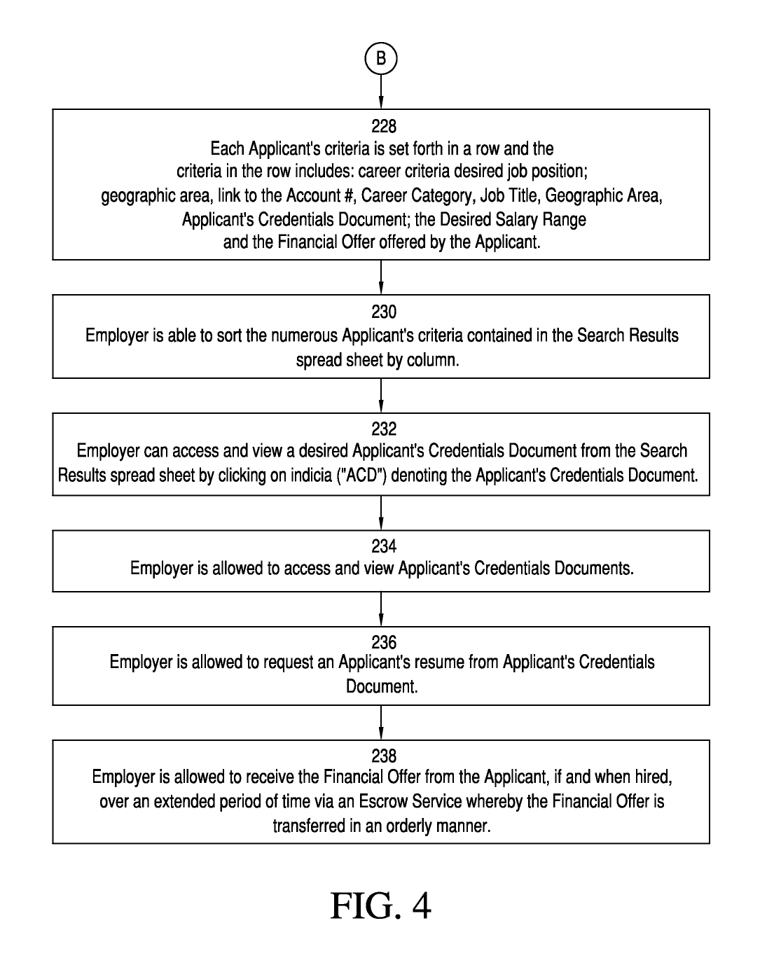

FIGS. 3-4 show Chart II, which illustrates the sequence of steps provided in the invention for an Employer. The inventive website includes a database 200, which is related also to the Applicant database 100. Upon visiting the website the Employer registers in the database 205. The invention by default is configured to not require Employer to pay a registration fee 210A, but may also be configured to require a registration fee 210B. In step 214 Employer completes a job posting material that is stored in the database in step 216. The Employer in step 222 is provided with a personal account wherein Employer can find and maintain Applicant's Credentials Documents sent in response to a job posting. Employer is allowed to search and find Applicant's Credentials Documents in step 224. In step 226 Employer is provided access to numerous Applicant's criteria in a Search Results spreadsheet format.

In step 228, each Applicant's criteria is set forth in a row and the criteria in a row includes: Account #, Career Category, Job Title, Geographic Area, Applicant's Credentials Document, Desired Salary Range and Financial Offer. The arrangement and selection of the criteria can be changed as desired. The Employer is able in step 230 to sort the numerous Applicants' criteria contained in the spread sheet by column as desired. The Employer can access and view a desired Applicant's Credentials Document from the Search Results spread sheet by clicking on the indicia (“ACD”). After clicking on the desired ACD, the Employer can view the desired Applicant's Credentials Document in step 234. The Employer is allowed in step 236 to request Applicant's resume from Applicant's Credentials Document. Employer is allowed to receive the Financial Offer from the Applicant, if and when hired, over an extended period of time via an Escrow Service whereby the Financial Offer is transferred in an orderly manner in step 238.

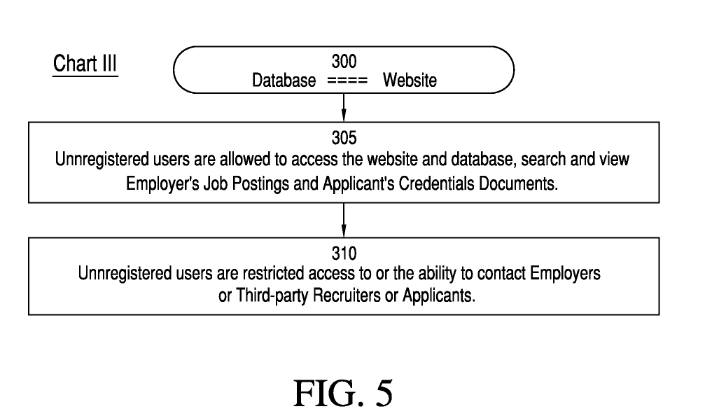

FIG. 5 shows Chart III, which illustrates the sequence of steps provided in the invention for unregistered users. The inventive website includes a database 300, which is related also to the Applicant database 100 and the Employer database 200. In step 305 unregistered users are allowed to access the inventive website and database, search and view Employer's Job Postings and Applicant's Credentials Documents. However, unregistered users are restricted in step 310 access to or the ability to contact Employers, Third-party Recruiters or Applicants.

FIGS. 6-7 show Chart IV, which illustrates the sequence of steps provided in the invention for a Third-party Recruiter. The inventive website includes a database 400, which is related also to the Applicant database 100, the Employer database 200 and the unregistered user database 300, each of which together form a relational database structure that is implemented on computer hardware and manipulated on the Internet. Upon visiting the website the Third-party Recruiter registers in the database 405. The invention by default is configured to not require Third-party Recruiter to pay a registration fee 410A, but may also be configured to require a registration fee 410B. In step 414 the Third-party Recruiter completes a job posting material that is stored in the database in step 416. In step 418 the Third-party Recruiter completes a form that includes criteria that will allow others to search for and find the job posting material. The job posting criteria is stored in a database in step 420. The Third-party Recruiter in step 422 is provided with a personal account wherein the Third-party Recruiter can find and maintain Applicant's Credentials Documents sent in response to a job posting. The Third-party Recruiter is allowed to search and find Applicant's Credentials Documents in step 424. In step 426 the Third-party Recruiter is provided access to numerous Applicant's criteria in a Search Results spreadsheet format.

In step 428, each Applicant's criteria is set forth in a row and the criteria in a row includes: Account #, Career Category, Job Title, Geographic Area, Applicant's Credentials Document, Desired Salary Range and Financial Offer. The arrangement and selection of the criteria can be changed as desired. The Third-party Recruiter is able in step 430 to sort the numerous Applicants' criteria contained in the spread sheet by column as desired. The Third-party Recruiter can access and view a desired Applicant's Credentials Document from the Search Results spread sheet by clicking on the indicia (“ACD”) in step 432. After clicking on the desired ACD, the Third-party Recruiter can view the desired Applicant's Credentials Document in step 434. The Third-party Recruiter is allowed in step 436 to request Applicant's resume from Applicant's Credentials Document. The Third-party Recruiter is allowed to receive the Financial Offer from the Applicant, if and when hired, over an extended period of time via an Escrow Service whereby the Financial Offer is transferred in an orderly manner in step 438.

FIG. 8 illustrates the Search Results spread sheet 600 and includes the Account #520, Career Category 525, Job Title 530, Geographic Area 535, Applicant's Credentials Document (“ACD”) 540, Desired Salary Range 545 and Financial Offer 550. The Applicant's Credentials Document indicia “ACD” can be clicked to open up the Applicant's Credentials Document 500 corresponding to the line on the spread sheet 600.

The Applicant's Credentials Document 500 is illustrated in more detail in FIG. 9. In the Applicant's Credentials Document 500, Applicant's Experience 505, Expertise 510 and Accomplishments 515 are provided in narrative, text block form. From the Applicant's Credentials Document 500, an Employer or Third-party Recruiter can Request Resume by clicking on the “Request Resume” link indicated at 555. The Salary Range is shown at 565 and the Financial Offer is shown at 570. When reviewing Applicant's Credentials Documents, the Employer, Third-party Recruiter or unregistered user can move to a different Applicant's Credentials Document by clicking on “Previous Summary” at 560 or “Next Summary” at 575.

The invention is not limited to the embodiments described herein and variations to the system and method, or steps provided or the order of the steps may also fall within the scope of the claims that follow.

What is claimed is:

1. An electronic employment method via a computer database accessible on a website on the Internet for networking and finding a job, wherein said database is located on computer hardware for storing and retrieving information and wherein said method comprises the steps of:
a. registering by an Applicant in said database;
b. completing by the Applicant a predefined Credentials Document that summarizes the Applicant's career points and storing said Credentials Document in said database;
c. completing by the Applicant a form that includes criteria that will allow others to search for and find the Applicant's Credentials Document and said criteria that is stored in said database;
d. making a non-binding offer by the Applicant to pay a set financial amount to an Employer, if and when hired;
e. allowing the Applicant to search for job postings on said database through said website and allowing the Applicant to send the Applicant's Credentials Document in response to said job postings;
f. allowing the Applicant's Credentials Document to be searched for and found by prospective Employers;
g. allowing the Applicant to receive requests for the Applicant's resume from said prospective Employers that have accessed and viewed the Applicant's Credentials Document;
h. allowing the Applicant to review and determine whether or not to release the Applicant's resume to a requesting Employer; and
i. allowing the Applicant to pay said set financial amount, if and when hired, to a hiring Employer over a predetermined period of time.

2. An electronic employment method according to claim 1 further comprising the steps of:
a. registering by the Employer in said database;
b. completing job posting material by the Employer and storing said job posting material in said database;
c. completing a form by the Employer that includes criteria that will allow others to search for and find the job posting material and storing said criteria in said database;
d. providing the Employer with a personal account wherein the Employer can find and maintain Applicants' Credentials Documents sent in response to a job posting;
e. allowing the Employer to search and find Applicants' Credentials Documents;
f. allowing the Employer to access and view Applicants' Credentials Documents; and
g. allowing the Employer to request an Applicant's resume from Applicant's Credentials Document.

3. An electronic employment method according to claim 1 wherein said method comprises the optional step of requiring the Applicant to pay a registration fee when registering.

4. An electronic employment method according to claim 1 comprising the additional step of summarizing the predefined Credentials Document into the areas of: Experience, Expertise and Accomplishments.

5. An electronic employment method according to claim 1 comprising the additional steps of maintaining the Applicant's identity as anonymous.

6. An electronic employment method according to claim 1 comprising the additional step of omitting any information regarding the Applicant's race, gender, age, religion, other protected status identifiers, and state of employment whereby profiling and discrimination by Employers is prevented.

7. An electronic employment method according to claim 1 comprising the additional step of allowing the Applicant to review other Applicants' Credentials Documents and non-binding offers.

8. An electronic employment method according to claim 1 comprising the additional step of allowing the Applicant to review how many times Applicant's Credentials Document has been viewed by registered Employers and by unregistered users.

9. An electronic employment method according to claim 1 comprising the additional step of allowing the Applicant to modify Applicant's Credentials Documents and the Applicant's non-binding offer at any time.

10. An electronic employment method according to claim 1 comprising the additional step of allowing the Applicant to transfer said set financial amount, if and when hired, to the hiring Employer over a period of time via an Escrow Service whereby said set financial amount is transferred in an orderly manner.

11. An electronic employment method according to claim 1 comprising the additional steps of allowing access to the website and said database by unregistered users whereby said unregistered users can search and view Applicants' Credentials Documents, and restricting unregistered users access to or the ability to contact Applicants.

12. An electronic employment method according to claim 2 comprising the additional optional step of requiring a registration fee from the Employer when registering.

13. An electronic employment method via the Internet according to claim 2 comprising the additional steps of providing access by the Employer to numerous Applicants' criteria in a Search Results spreadsheet format wherein each Applicant's criteria is set forth in a row and the criteria in the row includes: desired job position; geographic area, indicia denoting the Applicant's Credentials Document; the Desired Salary Range and the non-binding set financial amount offered by the Applicant.

14. An electronic employment method of claim 13 comprising the additional step of allowing Employer to sort the numerous Applicants' criteria contained in the Search Results spread sheet by column.

15. An electronic employment method of claim 13 comprising the additional step of allowing the Employer to access and view a desired Applicant's Credentials Document from the Search Results spread sheet by clicking on indicia denoting the Applicant's Credentials Document.

16. An electronic employment method of claim 15 comprising the additional step of restricting the Employer from requesting a resume or contacting an Applicant until the Employer has accessed and viewed the Applicant's Credentials Document.

17. An electronic employment method of claim 11 comprising the additional steps of allowing unregistered users to access the website, search and view the Employer's Job Posting, and restricting unregistered users' access to or the ability to contact the Applicant.

18. An electronic employment method of claim 1 comprising the additional step of allowing the hiring Employer to receive said set financial amount from the Applicant, if and when hired, over an extended period of time via an Escrow Service whereby said set financial amount is transferred in an orderly manner.

19. An electronic employment method of claim 2 comprising the additional steps of allowing a Third-party Recruiter to register and act on behalf of itself or Employers, and allowing said Third-party Recruiter to search and view Applicants' Credentials Documents, and allowing said Third-party Recruiter access to and the ability to contact Applicants.

20. An electronic employment system provided via the Internet on a website comprising:
a. a database on computer hardware for registering an Applicant;
b. said database being accessible on a website of the Internet;
c. a form in said database that includes fields for Applicant to complete with data to be included in an Applicant's Credentials Document and stored in said database;
d. a financial offer field to be completed with data in said database by the Applicant;
e. said financial offer comprises a set financial amount;
f. said Applicant's Credentials Document in said database being searchable by Employers, Third-party Recruiters and unregistered users;
g. said database includes provision to allow registered Employers and Third-party Recruiters to request resume from selected Applicant and a provision to allow Applicant to determine whether or not to release Applicant's resume from said database to the requesting Employer or Third-party Recruiter; and
h. said database includes a provision to allow Applicant to pay said set financial amount to said requesting Employer or said requesting Third-party Recruiter over a predetermined period of time if the Applicant is hired by said requesting Employer or as a result of contact from said Third-party Recruiter.
